(19) United States
(12) Patent Application Publication
(10) Pub. No.: US 2026/0180116 A1
(43) Pub. Date: Jun. 25, 2026

(54) Valve for an Electronic Component and Battery with such a Safety Valve

(71) Applicant: Illinois Tool Works Inc., Glenview, IL (US)

(72) Inventors: Melanie Sindel, Nuernberg (DE); Albert Sbongk, Niederstetten (DE); Jan Mueller, Wuerzburg (DE)

(21) Appl. No.: 19/412,450

(22) Filed: Dec. 8, 2025

(30) Foreign Application Priority Data
Dec. 23, 2024 (DE) 102024139649.0

(51) Int. Cl. H01M 50/342; H01M 10/0525

(52) U.S. Cl. CPC H01M 50/3425; H01M 10/0525; H01M 2200/20

(57) ABSTRACT

The disclosure relates to a safety valve (1) for an electronic component. The valve can open and equalize pressure with the surrounding atmosphere when a predetermined critical internal pressure is reached or exceeded inside the component's housing. The safety valve (1) includes a membrane (3) and an emergency degassing unit. When the critical pressure is reached, the emergency degassing unit punctures or slits the membrane (3), increasing its fluid permeability in the affected area to allow rapid pressure relief. The emergency degassing unit includes a piercing structure with at least one piercing tooth (5). In top view, the piercing tooth (5) may have a tri-lobular, hexagonal, polygonal, star-shaped, quadrilateral, X-shaped, K-shaped, C-shaped, Y-shaped, or otherwise irregular geometry.

### RELATED APPLICATION

The present application claims the benefit of German Patent Application No. DE 102024139649.0, filed Dec. 23, 2024, titled “Valve For An Electronic Component And Battery With Such A Safety Valve,” the contents of which are hereby incorporated by reference.

### BACKGROUND

Battery cells are used in a wide variety of applications as energy storage devices. In particular, they are employed in battery systems that include multiple battery cells electrically connected to one or more battery modules. Such battery systems are commonly used to supply the energy required for operating hybrid, plug-in hybrid, or fully electric vehicles. Lithium-ion cells are particularly preferred as battery cells. Prismatic battery cells, which include a rigid metallic cell housing, are frequently used. These metallic housings (also referred to as hard cases) protect the battery cell, in particular, against the ingress of moisture and against the outward diffusion of electrolyte solvent molecules from the cell interior.

If a battery cell heats beyond a certain temperature, it may undergo what is known as degassing. Malfunctions-such as an internal short circuit between electrodes, overcharging during a charging cycle, or exposure to extremely high ambient temperatures—can cause such critical heating. As a consequence of this critical heating, undesired chemical reactions may occur inside the battery cell, potentially leading to what is referred to as thermal runaway. In particular, the electrolyte required for ion transport between the electrodes may decompose under critical heating and transition to a gaseous state.

The formation of such gases causes a rapid increase in internal pressure within the battery cell. A safety valve integrated into the cell housing prevents the cell from rupturing. When the internal pressure exceeds a specified threshold, the safety valve opens, allowing the gases and potentially additional decomposition products generated within the cell to escape as a fluid from the housing.

A lithium-ion cell equipped with a safety valve is disclosed, for example, from publication DE 103 28 862 B4, in which the safety valve is implemented as a metallic burst membrane. Such a membrane may be designed to rupture when the internal cell pressure reaches approximately 6 bar. By contrast, publication DE 10 2007 061 784 A1 discloses a safety valve for a lead-acid battery that is configured as a valve plug. To allow rapid pressure relief within the housing even at relatively low degassing pressures, publication DE 10 2021 129 752 A1 discloses a degassing unit serving as a safety valve in which a membrane is punctured by an emergency-venting mandrel when a critical internal pressure is reached.

The safety valve disclosed in DE 10 2021 129 752 A1 has the limitation that, particularly at low critical internal pressures, puncturing the membrane with the emergency-venting mandrel may not reliably cause the membrane to rupture. One possible solution is to provide the membrane with a weakened region, such as a linear weakened area.

However, introducing such weakened regions into the membrane is relatively complex. Moreover, the sequence of events when the safety valve is actuated cannot be precisely predetermined. There remains a risk that the membrane will still fail to rupture when the critical internal pressure is reached, or will rupture only after an additional pressure increase within the housing.

The disclosure is therefore based on the objective of further developing the safety valve so that, after puncturing, the membrane will reliably burst, thereby enabling pressure equalization in the shortest possible time.

### SUMMARY OF THE DISCLOSURE

The present disclosure relates generally to a safety valve, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 schematically and in a sectional view, an exemplary embodiment of the safety valve according to the disclosure.

FIG. 2 schematically and from a top view, an exemplary embodiment of a piercing tooth of the emergency degassing unit of the safety valve according to FIG. 1.

FIG. 3 schematically and from a top view, an alternative embodiment of a piercing tooth of an emergency degassing unit of the safety valve according to FIG. 1.

FIG. 4 schematically and from a top view, an exemplary embodiment of a membrane of the safety valve according to FIG. 1, which is shown after actuation of the safety valve.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a safety valve for an electronic component. The safety valve is in particular part of a degassing unit. In particular, the disclosure relates to a safety valve for a battery case with least one battery cell housed in the battery case. The at least one battery cell is preferably a secondary cell, and in particular a lithium-ion battery cell.

The safety valve according to the disclosure is configured to open when an internal pressure prevailing within a housing of the electronic component surpasses a threshold, and thus to allow a medium to flow out of the housing.

Accordingly, the disclosure relates to a safety valve for an electronic component, in particular for a battery case or a battery cell housing with at least one battery cell housed in the battery case or battery cell housing. The safety valve according to the disclosure is designed to be actuated and achieve pressure equalization with respect to atmospheric pressure when a particularly previously determined or determinable critical internal pressure is reached or exceeded in a housing of the electronic component.

For this purpose, the safety valve according to the disclosure comprises a membrane and an emergency degassing unit. The emergency degassing unit is designed to puncture the membrane when the critical internal pressure is reached or exceeded in such a way that, at least in the punctured area of the membrane, fluid permeability of the membrane that is necessary and/or desired for pressure equalization is increased accordingly.

The safety valve according to the disclosure is particularly characterized by the emergency degassing unit comprising a piercing arrangement in the form of a tooth structure with at least one piercing tooth, wherein, from a top view of the at least one piercing tooth, such tooth comprises tri-lobular, hexagonal, polygonal, star-shaped, quadrilateral, X-shaped, K-shaped, C-shaped, Y-shaped or irregularly shaped geometry.

The advantages achievable with the solution according to the disclosure are obvious. Instead of an emergency degassing mandrel as known from the publication DE 10 2021 129 752 A1, the membrane is punctured over a large area with the piercing tooth of the piercing arrangement when the safety valve is actuated so that bursting of the membrane is ensured even at a relatively low critical internal pressure. In particular, the solution according to the disclosure allows the membrane to be configured without weak areas.

In particular, the piercing tooth of the piercing arrangement allows the membrane to be first punctured and then slit when the safety valve is actuated.

The particular geometry and configuration of the at least one piercing tooth result in the membrane being punctured via a tip of the piercing tooth when the safety valve is actuated, and subsequently, further movement of the piercing tooth relative to the membrane transforms the puncture into linear punctures or slits. This ensures reliable bursting of the membrane even at a low critical internal pressure.

According to preferred implementations of the safety valve according to the disclosure, the at least one piercing tooth has a point-symmetry configuration, in particular an X-shaped or Y-shaped configuration, when viewed from a top view.

When viewed from a top view, the piercing tooth comprises a plurality of leg regions that converge at a particularly central intersection point, wherein each leg region preferably has a triangular cross-sectional configuration, in particular in the form of an isosceles, acute triangle. However, other cross-sectional configurations of the respective leg regions are conceivable.

Particularly preferably, the at least one piercing tooth has a plurality of cutting edges for introducing cuts into the membrane upon actuation of the safety valve. Preferably, the cutting edges are designed to be converging and preferably converge at a central intersection point with respect to the at least one piercing tooth. In particular, the intersection point forms the tip of the at least one piercing tooth, which, when the safety valve is actuated, first reaches and punctures the membrane.

In particular, the central intersection point is configured such that, when the safety valve is actuated, the membrane is first punctured in the area of the central intersection point.

According to implementations of the safety valve according to the disclosure, it is provided, when viewed from a side view, that the at least one piercing tooth has a triangular configuration, in particular in the form of an isosceles, obtuse triangle or in the form of an isosceles, acute triangle.

This design variant allows, in an easily realized, but nevertheless effective manner, the membrane to be punctured first in the region of the central intersection point or the tip of the piercing tooth, wherein corresponding slits are subsequently made in the membrane and proceed from the punctured region of the membrane.

For this purpose, it is preferred that the sides of the triangular configuration of the at least one piercing tooth seen from a side view are each formed by a cutting edge.

According to design variants of the safety valve according to the disclosure, it comprises a base body that can be connected to an edge of a pressure equalization aperture of the housing of the electronic component in a fluid-tight manner with a gas passage aperture covered by the membrane.

It is conceivable that the at least one piercing tooth of the emergency degassing unit extends outwardly in the axial direction to the membrane, wherein a tip of the at least one piercing tooth is present at a previously determined or determinable distance from the external membrane surface in an idle state of the safety valve. It is particularly suitable for the piercing arrangement to be configured with the at least one piercing tooth on the base body or connected to the base body.

According to an alternative design variant, the safety valve according to the disclosure comprises a base body that can be connected to an edge of a pressure equalization aperture of the housing of the electronic component in a fluid-tight manner with a gas passage aperture covered by the membrane, wherein the at least one piercing tooth of the emergency degassing unit extends outwardly in the axial direction to the membrane, and wherein a tip of the at least one piercing tooth is present at a previously determined or determinable distance from the external membrane surface in an idle state of the safety valve. In addition, the safety valve may comprise a cover, which is externally connected to the base body, wherein the cover preferably comprises at least one ventilation aperture.

In this alternative embodiment of the safety valve according to the disclosure, the piercing arrangement can be configured with the at least one piercing tooth on the cover or connected to the cover.

Preferably, the membrane is configured semi-permeably and is designed to enable a passage of gaseous media from an environment into the housing of the electronic component and vice versa, but to prevent the passage of liquid media and/or solids.

Alternatively, however, it is also conceivable to design the membrane as a bursting disk.

The disclosure further relates to a battery with at least one battery cell housed in a battery case, as well as with at least one safety valve of the aforementioned type according to the disclosure incorporated into a pressure equalization aperture of the battery case.

In particular, the at least one battery cell is configured as a secondary cell, in particular in the form of a lithium-ion cell.

The exemplary embodiment of the safety valve 1 according to the disclosure is in particular a safety valve 1 for, for example, a battery comprising at least one battery cell housed in a battery case. The safety valve 1 can be incorporated into a pressure equalization aperture of the battery housing. The battery cell is in particular a secondary cell, preferably in the form of a lithium-ion cell.

The safety valve 1 is designed to be actuated and achieve pressure equalization with respect to atmospheric pressure when a particularly previously determined or determinable critical internal pressure is reached or exceeded in the battery case.

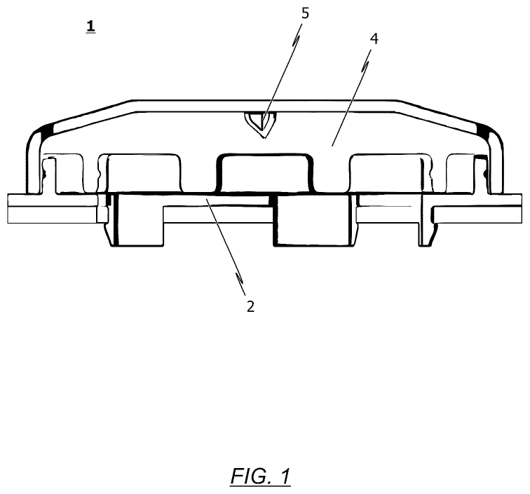

For this purpose, the safety valve 1 comprises a membrane 3 (not directly visible in FIG. 1) and an emergency degassing unit. The emergency degassing unit is designed to puncture the membrane 3 when the critical internal pressure is reached or exceeded in such a way that, at least in the punctured area of the membrane 3, fluid permeability of the membrane 3 that is necessary and/or desired for pressure equalization is increased accordingly.

Specifically, the safety valve 1, shown schematically for example in FIG. 1, comprises a base body 2 that can be connected to an edge of a pressure equalization aperture of the housing of the electronic component in a fluid-tight manner with a gas passage aperture covered by the membrane 3.

The emergency degassing unit has a piercing arrangement in the form of a tooth structure with a piercing tooth. In the embodiment of the safety valve 1 according to the disclosure shown in FIG. 1, the piercing tooth of the emergency degassing unit extends outwardly in the axial direction to the membrane 3. The tip of the piercing tooth is at a previously determined or determinable distance from the external membrane surface.

The safety valve 1 shown schematically in FIG. 1 further comprises a cover 4, which is externally connected to the base body 2 of the safety valve 1. The cover 4 preferably comprises at least one ventilation aperture.

It can further be seen that the piercing arrangement is configured with a piercing tooth 5 on the cover 4.

Of course, it is also conceivable that the piercing arrangement is configured with the piercing tooth 5 on the base body 2 of the safety valve 1.

With respect to the piercing tooth 5 of the emergency degassing unit, it is provided that, when seen from a top view of the at least one piercing tooth 5, such tooth comprises tri-lobular, hexagonal, polygonal, star-shaped, quadrilateral, X-shaped, K-shaped, C-shaped, Y-shaped or irregularly shaped geometry.

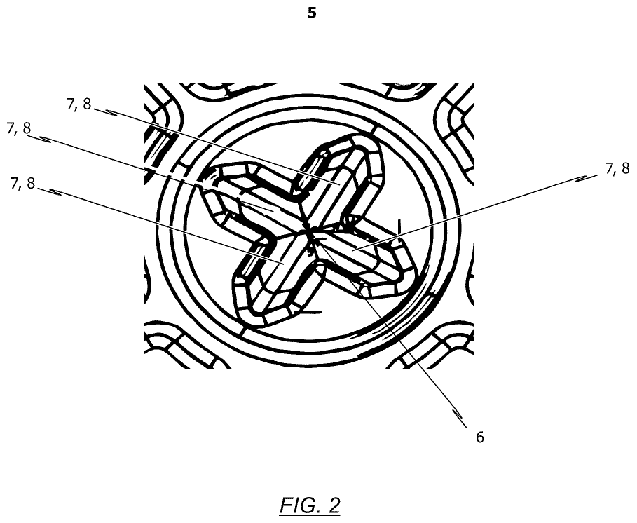

The exemplary embodiment of the piercing tooth 5 shown from a top view in FIG. 2 has an X-shaped geometry.

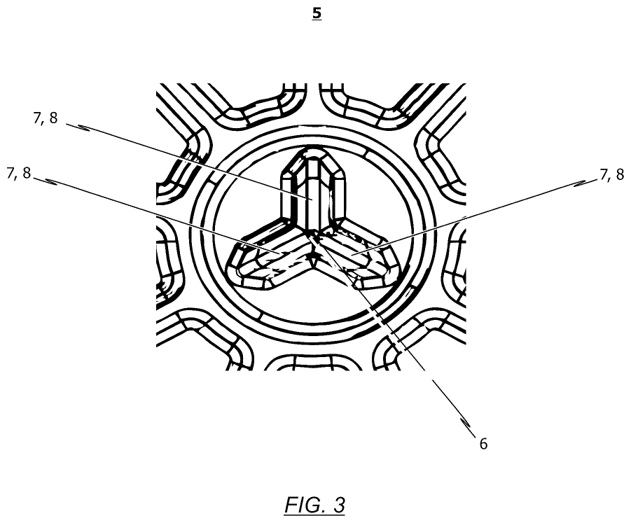

On the other hand, the exemplary embodiment of the piercing tooth 5 shown in FIG. 3 has a Y-shaped geometry. Of course, other geometries of the piercing tooth 5 are also conceivable.

The embodiments of the piercing tooth 5 shown in FIG. 2 and FIG. 3 have in common that-when viewed from a top view, each of the piercing teeth 5 has a plurality of leg regions 7 which converge at a central intersection point.

Preferably, each leg region 7 comprises a triangular cross-sectional configuration, in particular in the form of an isosceles, acute triangle.

Moreover, the piercing teeth 5 shown in FIG. 2 and FIG. 3 each have a plurality of cutting edges 8. The cutting edges 8 are designed to be converging and converge at a central intersection point 6 with respect to the piercing tooth 5.

The central intersection point 6 is configured such that, when the safety valve 1 is actuated, the membrane 3 is first punctured in the area of the central intersection point 6.

Then, starting from the punctured region of the membrane 3, corresponding cuts are introduced into the membrane 3 using the cutting edges 8. This results in ensuring that the membrane 3 abruptly fails and bursts when the safety valve 1 is actuated, even at a low critical internal pressure.

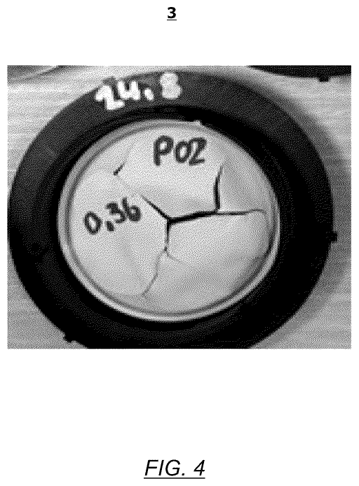

In FIG. 4, a top view shows a membrane 3 of the safety valve 1 after it has been destroyed with the aid of a piercing tooth 5 according to FIG. 3.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Safety valve
2 Base body
3 Membrane
4 Cover
5 Piercing tooth
6 Central intersection point/tip of the piercing tooth
7 Leg region
8 Cutting edge

What is claimed is:

1. A safety valve (1) for an electronic component,
wherein the safety valve (1) is designed to be actuated and achieve pressure equalization with respect to atmospheric pressure when a particularly previously determined or determinable critical internal pressure is reached or exceeded in a housing of the electronic component,
wherein the safety valve (1) comprises a membrane (3) and an emergency degassing unit,
wherein the emergency degassing unit is designed to puncture and/or slit the membrane (3) when the critical internal pressure is reached or exceeded in such a way that, at least in the punctured and/or slit area of the membrane (3), fluid permeability of the membrane (3) that is necessary and/or desired for pressure equalization is increased accordingly,
wherein the emergency degassing unit comprises a piercing arrangement in the form of a tooth structure with at least one piercing tooth (5), and
wherein, from a top view of the at least one piercing tooth (5), such tooth comprises tri-lobular, hexagonal, polygonal, star-shaped, quadrilateral, X-shaped, K-shaped, C-shaped, Y-shaped or irregularly shaped geometry.

2. The safety valve (1) according to claim 1, wherein, when viewed from a top view, the at least one piercing tooth (5) has a point-symmetry configuration, the point-symmetry configuration being an X-shaped or Y-shaped configuration.

3. The safety valve (1) according to claim 1, wherein, when viewed from a top view, the at least one piercing tooth (5) comprises a plurality of leg regions (7) that converge at a particularly central intersection point (6), wherein each leg region has a triangular cross-sectional configuration in the form of an isosceles, acute triangle.

4. The safety valve (1) according to claim 1, wherein the at least one piercing tooth (5) comprises a plurality of cutting edges (8).

5. The safety valve (1) according to claim 4, wherein the cutting edges (8) are designed to be converging and converge at a central intersection point (6) with respect to the at least one piercing tooth (5).

6. The safety valve (1) according to claim 3, wherein the in particular central intersection point (6) is configured such that, when the safety valve is actuated, the membrane (3) is first punctured in the area of the central intersection point.

7. The safety valve (1) according to claim 1, wherein, when viewed from a side view, the at least one piercing tooth (5) has a triangular configuration, in the form of an isosceles, obtuse triangle or in the form of an isosceles, acute triangle.

8. The safety valve (1) according to claim 7, wherein the sides of the triangular configuration of the piercing tooth (5) seen from a side view are each formed by a cutting edge (8).

9. The safety valve (1) according to claim 1, wherein the safety valve (1) comprises a base body (2) that can be connected to an edge of a pressure equalization aperture of the housing of the electronic component in a fluid-tight manner with a gas passage aperture covered by the membrane (3), wherein the at least one piercing tooth (5) of the emergency degassing unit extends outwardly in the axial direction to the membrane (3), and wherein a tip (6) of the at least one piercing tooth (5) is present at a previously determined or determinable distance from the external membrane surface, wherein the piercing arrangement with the at least one piercing tooth (5) is formed or arranged on the base body (2).

10. The safety valve (1) according to claim 1, wherein the safety valve (1) comprises a base body (2) that can be connected to an edge of a pressure equalization aperture of the housing of the electronic component in a fluid-tight manner with a gas passage aperture covered by the membrane (3), wherein the at least one piercing tooth (5) of the emergency degassing unit extends outwardly in the axial direction to the membrane (3), and wherein a tip (6) of the at least one piercing tooth (5) is present at a previously determined or determinable distance from the external membrane surface, wherein the safety valve (1) further comprises a cover (4), which is externally connected to the base body (2), wherein the cover (4) comprises at least one ventilation orifice, and wherein the piercing arrangement is configured with the at least one piercing tooth (5) on the cover (4) or connected to the cover (4).

11. The safety valve (1) according to claim 1, wherein the membrane (3) is configured semi-permeably and is designed to enable a passage of gaseous media from an environment into the housing of the electronic component and vice versa, but to prevent the passage of liquid media and/or solids.

12. The safety valve (1) according to claim 1, wherein the membrane (3) is configured as a bursting disk.

13. A battery with at least one battery cell housed in a battery case and with at least one safety valve (1) incorporated in a pressure equalization aperture of the battery housing according to claim 1.

14. The battery according to claim 13, wherein the at least one battery cell is configured as a secondary cell in the form of a lithium-ion cell.

15. A safety valve for an electronic component, the safety valve being configured to actuate in response to an internal pressure within a housing of the electronic component reaching or exceeding a predetermined critical pressure, the actuation allowing pressure equalization with atmospheric pressure, the safety valve comprising:
a membrane configured to cover a gas-passage aperture of the housing; and
an emergency degassing unit including a piercing arrangement having at least one piercing tooth positioned to puncture and/or slit the membrane when the critical pressure is reached or exceeded to increase fluid permeability of the membrane in a punctured and/or slit region,
wherein the at least one piercing tooth, when viewed from a top view, has a tri-lobular, hexagonal, polygonal, star-shaped, quadrilateral, X-shaped, K-shaped, C-shaped, Y-shaped, or irregular geometry.

16. The safety valve of claim 15, wherein the at least one piercing tooth exhibits point symmetry when viewed from a top view.

17. The safety valve of claim 15, wherein the at least one piercing tooth comprises a plurality of leg regions extending radially and converging at a central intersection point, each leg region having a triangular cross-section in the form of an isosceles acute triangle.

18. The safety valve of claim 15, wherein the at least one piercing tooth includes a plurality of cutting edges.

19. The safety valve of claim 18, wherein the cutting edges converge toward a central intersection point of the piercing tooth.

20. The safety valve of claim 17, wherein the central intersection point defines an initial puncture site, such that the membrane is first punctured at the intersection point when the critical pressure is reached.
